(19) United States
(12) Patent Application Publication
(10) Pub. No.: US 2012/0168196 A1
(43) Pub. Date: Jul. 5, 2012

(54) COAXIAL CABLE STRUCTURE

(75) Inventor: Ching-Yang Chiu, Taipei (TW)

(73) Assignee: PRIMECON TECHNOLOGY LTD., Taipei (TW)

(21) Appl. No.: 12/984,374

(22) Filed: Jan. 4, 2011

(51) Int. Cl. H01B 7/17

(52) U.S. Cl. 174/107

(57) ABSTRACT

A coaxial cable structure includes a central conductor, an insulating layer surrounding the central conductor, a shielding layer wound around the insulating layer and including at least a wire dip-coated with a coating, and an outer jacket surrounding the shielding layer. The coaxial cable structure uses a shielding layer wound around the insulating layer to replace the woven shielding layer used in prior art coaxial cables to provide enhanced shielding effect while allowing the coaxial cable to be manufactured with reduced material in upgraded efficiency.

### FIELD OF THE INVENTION

The present invention relates to a coaxial cable structure, and more particularly to a coaxial cable structure that uses a shielding layer wound around an insulating layer to replace the conventional woven shielding layer in order to provide enhanced shielding effect while allowing the coaxial cable to be manufactured with reduced material in upgraded efficiency.

### BACKGROUND OF THE INVENTION

Generally, a conventional coaxial cable 2 as shown in FIGS. 1 and 2 includes a central conductor 21, an insulating layer 22 surrounding the central conductor 21, a woven shielding layer 23 surrounding the insulating layer 22, and an outer jacket 24 surrounding the woven shielding layer 23. The coaxial cable 2 is used with connectors (not shown) for transmitting signals between electronic apparatus.

The conventional coaxial cable 2 uses the woven shielding layer 23 to prevent interference by noise. However, the woven shielding layer 23 is formed by interlacing and weaving a plurality of very thin wires into a multi-layer structure. Due to the woven shielding layer 23, the conventional coaxial cable 2 is disadvantageously manufactured with increased material in low efficiency. Moreover, since there are voids formed on the woven shielding layer 23, the coaxial cable 2 in practical use tends to have relatively poor shielding effect.

It is therefore desirable to develop a coaxial cable structure that replaces the conventional woven shielding layer with an improved shielding layer without voids or clearances, so that the coaxial cable can be manufactured with reduced material in upgraded efficiency and provide better shielding effect.

### SUMMARY OF THE INVENTION

A primary object of the present invention is to provide a coaxial cable structure that uses a shielding layer wound around an insulating layer to replace the conventional woven shielding layer in order to provide enhanced shielding effect while allowing the coaxial cable to be manufactured with reduced material in upgraded efficiency.

To achieve the above and other objects, the coaxial cable structure according to the present invention includes a central conductor; an insulating layer surrounding the central conductor; a shielding layer wound around the insulating layer and including at least one wire, and the wire being dip-coated to form a coating on an outer surface thereof; and an outer jacket surrounding the shielding layer.

In an embodiment of the present invention, the central conductor is made of a copper material.

In an embodiment of the present invention, the insulating layer can be made of plastics, rubber, polytetrafluoroethylene (PTFE), polyvinylchloride (PVC), or other equivalent materials.

In an embodiment of the present invention, the shielding layer is formed by winding a wire around the insulating layer, and the coating on the wire is formed of a metal material.

In another embodiment of the present invention, the shielding layer is formed by arranging a plurality of parallel and axially extended wires around the insulating layer, and the coating on the wire is formed of a metal material.

In an embodiment of the present invention, the metal material for forming the coating on the wire can be tin, nickel, or other metal materials with similar property.

In an embodiment of the present invention, the outer jacket can be made of plastics, rubber, PTFE, PVC, or other equivalent materials.

With the above arrangements, the coaxial cable structure of the present invention using a shielding layer wound around an insulating layer to replace the conventional woven shielding layer can provide enhanced shielding effect while allowing the coaxial cable to be manufactured with reduced material in upgraded efficiency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a plan view showing a conventional coaxial cable;

FIG. 2 is a cross-sectional view of the conventional coaxial cable of FIG. 1;

FIG. 3 is a plan view showing a coaxial cable structure according to a first embodiment of the present invention;

FIG. 4 is a cross-sectional view of the coaxial cable structure according to the first embodiment of the present invention;

FIG. 5 is a plan view showing a coaxial cable structure according to a second embodiment of the present invention; and

FIG. 6 is a cross-sectional view of the coaxial cable structure according to the second embodiment of the present invention.

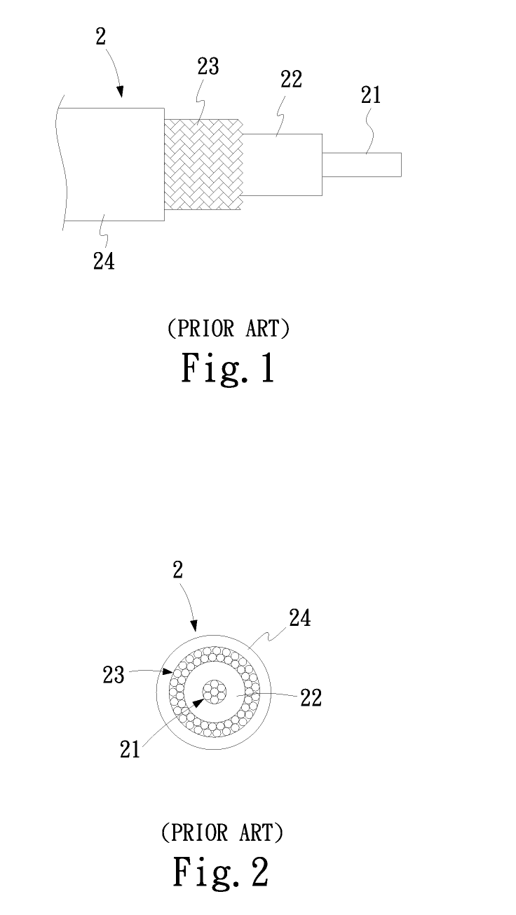

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

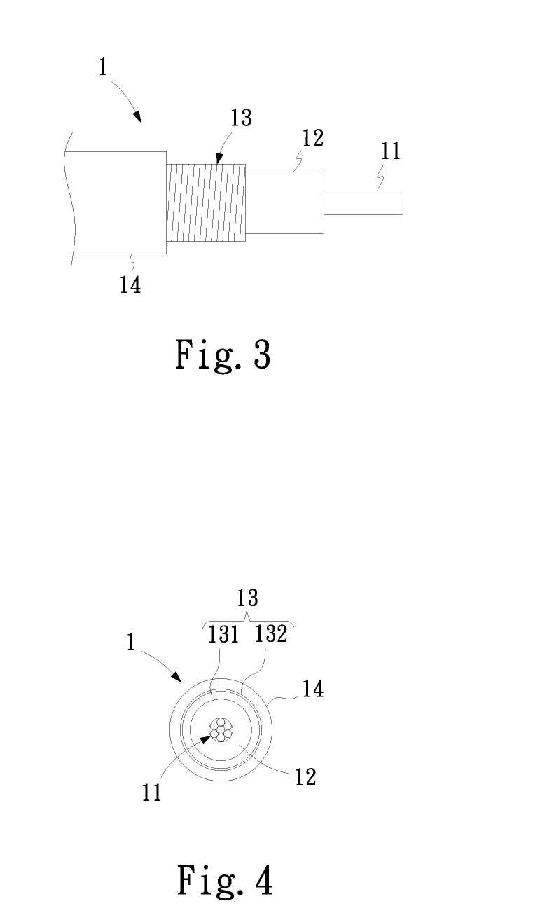

Please refer to FIGS. 3 and 4 that are plan and cross-sectional views, respectively, of a coaxial cable structure 1 according to a first embodiment of the present invention. As shown, the coaxial cable structure 1 in the first embodiment of the present invention includes a central conductor 11, an insulating layer 12, a shielding layer 13, and an outer jacket 14.

The central conductor 11 can be made of a copper material.

The insulating layer 12 surrounds the central conductor 11 and can be made of plastics, rubber, polytetrafluoroethylene (PTFE), polyvinylchloride (PVC), or other equivalent materials.

The shielding layer 13 is externally wound around the insulating layer 12 and includes at least a wire 131. The wire 131 is dip-coated to form a coating 132 on an outer surface thereof. The coating 132 can be a metal material, which can be tin, nickel, or other materials with similar property.

The outer jacket 14 surrounds the shielding layer 13 and can be made of plastics, rubber, PTFE, PVC, or other equivalent materials.

To manufacturing the coaxial cable structure 1 according to the first embodiment of the present invention, first form the central conductor 11 and the insulating layer 12. Then, wind a wire 131 around the insulating layer 12 in a direction substantially perpendicular to the central conductor 11. The wire 131 is dip-coated with a metal material to form a metallic coating 132 on an outer surface of the wire 131. Therefore, the wire 131 wound around the insulating layer 12 forms a shielding layer 13 that has a tight structure without leaving any void or clearance thereon. Finally, form an outer jacket 14 to surround the shielding layer 13 and complete the coaxial cable structure 1 of the present invention. The coaxial cable structure 1 can be manufactured with reduced material in upgraded efficiency. The coaxial cable structure 1 can be used with connectors (not shown) to transmit signals between electronic apparatus, and the shielding layer 13 can effectively prevent interference by noise in the process of signal transmission via the coaxial cable structure 1. That is, the coaxial cable structure 1 of the present invention can have improved shielding effect.

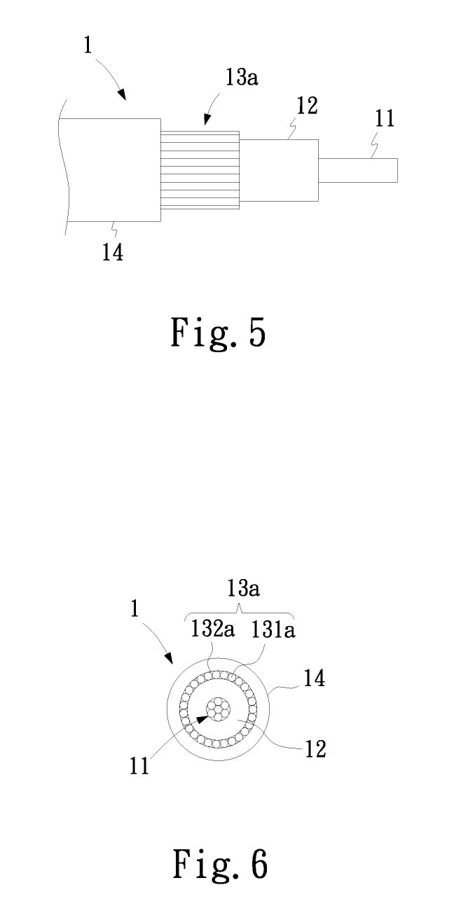

FIGS. 5 and 6 are plan and cross-sectional views, respectively, of a coaxial cable structure 1 according to a second embodiment of the present invention. As shown, the coaxial cable structure 1 in the second embodiment is generally structurally similar to the first embodiment except that the insulating layer 12 is surrounded by a shielding layer 13a that is formed from a plurality of parallel wires 131a extended in a direction parallel with the central conductor 11 and tightly arranged around an outer surface of the insulating layer 12 without leaving any void or clearance between any adjacent wires 131a. Finally, the outer jacket 14 is externally formed around the shielding layer 13a. The wires 131a are respectively coated with a metal material to form a coating 132a thereon. The metal material can be tin, nickel or other metal materials having similar property. With these arrangements, the coaxial cable structure 1 in the second embodiment can achieve the same effect as the first embodiment.

The coaxial cable structure of the present invention is novel, improved and industrially practical for use. The present invention is novel and improved because the shielding layer wound around the insulating layer can replace the conventional woven shielding layer to provide improved shielding effect while allowing the coaxial cable to be manufactured with reduced material in upgraded efficiency. The present invention is industrially practical for use because products derived from the present invention would no doubt fully satisfy the current market demands.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A coaxial cable structure, comprising:
a central conductor;
an insulating layer surrounding the central conductor;
a shielding layer being arranged around the insulating layer and including at least one wire;
and the wire being dip-coated to form a coating on an outer surface thereof; and
an outer jacket surrounding the shielding layer.

2. The coaxial cable structure as claimed in claim 1, wherein the central conductor is made of a copper material.

3. The coaxial cable structure as claimed in claim 1, wherein the insulating layer is made of a material selected from the group consisting of plastics, rubber, polytetrafluoroethylene (PTFE), polyvinylchloride (PVC), and other equivalent materials.

4. The coaxial cable structure as claimed in claim 1, wherein the shielding layer is formed by winding the wire around the insulating layer, and wherein the coating is a metal material.

5. The coaxial cable structure as claimed in claim 4, wherein the metal material forming the coating is selected from the group consisting of tin, nickel, and other materials with similar property.

6. The coaxial cable structure as claimed in claim 1, wherein the shielding layer is formed by arranging a plurality of parallel and axially extended wires around the insulating layer, and wherein the coating is a metal material.

7. The coaxial cable structure as claimed in claim 6, wherein the metal material forming the coating is selected from the group consisting of tin, nickel, and other materials with similar property.

8. The coaxial cable structure as claimed in claim 1, wherein the outer jacket is made of a material selected from the group consisting of plastics, rubber, polytetrafluoroethylene (PTFE), polyvinylchloride (PVC), and other equivalent materials
